(19) United States
(12) Patent Application Publication
(10) Pub. No.: US 2025/0232686 A1
(43) Pub. Date: Jul. 17, 2025

(54) SYSTEMS AND METHODS FOR PROVIDING CONTEXTUALLY RELEVANT VEHICLE INSTRUCTIONS

(71) Applicant: Ford Global Technologies, LLC, Dearborn, MI (US)

(72) Inventor: Amber Michelle Lundy, Marana, AZ (US)

(21) Appl. No.: 18/411,621

(22) Filed: Jan. 12, 2024

(51) Int. Cl. G09B 5/02; G06F 16/9535; G06T 19/00; G10L 15/18; G10L 15/22; G10L 25/63

(52) U.S. Cl. CPC G09B 5/02; G06F 16/9535; G06T 19/003; G10L 15/1822; G10L 15/22; G10L 25/63

(57) ABSTRACT

A system to output vehicle instructions is disclosed. The system may include a transceiver, a memory and a processor. The transceiver may be configured to receive a user input associated with a vehicle from a user, and the memory may be configured to store a trained machine model. The trained machine model may be trained by using a training data that includes a plurality of vehicle component identifiers and a plurality of user command intents. The processor may be configured to obtain the user input and determine a user intent based on the user input. The processor may be further configured to identify a vehicle component associated with the user intent by executing instructions stored in the trained machine model, and generate an instructional media content based on the vehicle component and the user intent. The processor may further output the instructional media content.

### FIELD

The present disclosure relates to systems and methods for providing contextually relevant vehicle instructions to a user.

### BACKGROUND

There are known instances of users seeking assistance when they need to repair their vehicles or need guidance to operate one or more vehicle components. For example, a user may seek assistance when the wipers may not be cleaning the windshield properly or when the user may not know the procedure to operate a new vehicle feature or component. In such situations, the users typically review the owner manuals or search for “how-to” videos on the Internet to obtain the required assistance.

Searching for how-to videos on the Internet can be a cumbersome exercise, and may not be effective as most of such videos are generic in nature and do not provide the specific instructions that the users may be looking for. Further, the owner manuals too are generic in nature and may not provide assistance to the users in all scenarios. Furthermore, the owner manuals typically include technical jargons that a layman may find difficult to understand.

Therefore, a system is required that provides assistance to vehicle users in an easy-to-understand manner.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a block diagram of an example vehicle instruction generation system in accordance with the present disclosure.

FIG. 3 depicts a three-dimensional (3D) digital vehicle model being displayed on a vehicle Human-Machine Interface (HMI) in a default view angle in accordance with the present disclosure.

FIG. 4 depicts a sequence of views being displayed on the vehicle HMI illustrating a movement of the 3D digital vehicle model from the default view angle to an optimal view angle in accordance with the present disclosure.

FIG. 5 depicts a flow diagram of an example vehicle instruction generation method in accordance with the present disclosure.

### DETAILED DESCRIPTION

### Overview

The present disclosure describes a vehicle instruction generation system (“system”) that may be configured to generate and provide instructional or educational media content to a vehicle user that may assist the user in efficiently operating, repairing and/or maintaining one or more vehicle components associated with a vehicle. The user may provide a user input to the system when the user desires to seek assistance from the system regarding one or more vehicle components. As an example, the user may provide the user inputs when one or more vehicle components may not be operating properly or need to be replaced, when the user may seek guidance to operate a new vehicle feature/component, and/or the like. In an exemplary aspect, the user input may be a natural language based voice command. The system may obtain the user input from the user and may generate an instructional or educational media content (e.g., a “how-to” video) based on the user input, which may assist the user in conveniently learning about the procedure to repair, install, replace and/or operate the associated vehicle component(s).

In some aspects, the system may be an Artificial Intelligence (AI)/Machine Learning (ML) based system that may analyze the user input and accordingly generate an optimal instructional media content that may efficiently assist the user. The system may include a Large Language Model (LLM) agent that may include one more trained machine learning modules and/or algorithms that may analyze the user input and generate the instructional media content.

In an exemplary aspect, responsive to obtaining the user input from the user, the system may determine a user intent based on the user input by performing natural language processing of the user input. The system may perform the natural language processing of the user input by executing the instructions stored in one or more LLM agent modules. The user intent may indicate an exact user requirement (especially if the user input is vague or implicit) and/or a reason or a context that may have led the user to provide the user input to the system. Responsive to determining the user intent, the system may execute the instructions stored in the LLM agent to identify one or more vehicle components associated with the user intent, and then generate the instructional media content on the fly based on the identified vehicle component(s) and the user intent. The system may further cause a display screen associated with a vehicle Human-Machine Interface (HMI) and/or a user device to display the generated instructional media content, to enable the user to conveniently view the instructional media content.

In some aspects, the system may cause the display screen to display/play the instructional media content by using a three-dimensional (3D) digital vehicle exterior and interior model (that may be pre-stored in a system memory). The system may be configured to determine an optimal view angle associated with the 3D digital vehicle exterior and interior model based on the identified vehicle component(s) and the user intent, and cause the display screen to display the instructional media content at the optimal view angle so that the user may efficiently and easily comprehend the media content.

The present disclosure discloses a vehicle instruction generation system that generates and provides contextually relevant instructional media content or “how-to” videos to the user based on user's requirements. By using the system, the user is not required to search for generic videos on the Internet or review owner/user manuals to learn about the vehicle components. The system operates by obtaining voice based commands from the user, thereby considerably enhancing user's convenience. Further, the system generates the instructional media content based on user's specific needs and requirements, and hence the generated media content is highly relevant for the user. The system further ensures that the generated media content is displayed to the user at an optimal view angle so that the user may efficiently and easily comprehend the media content.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

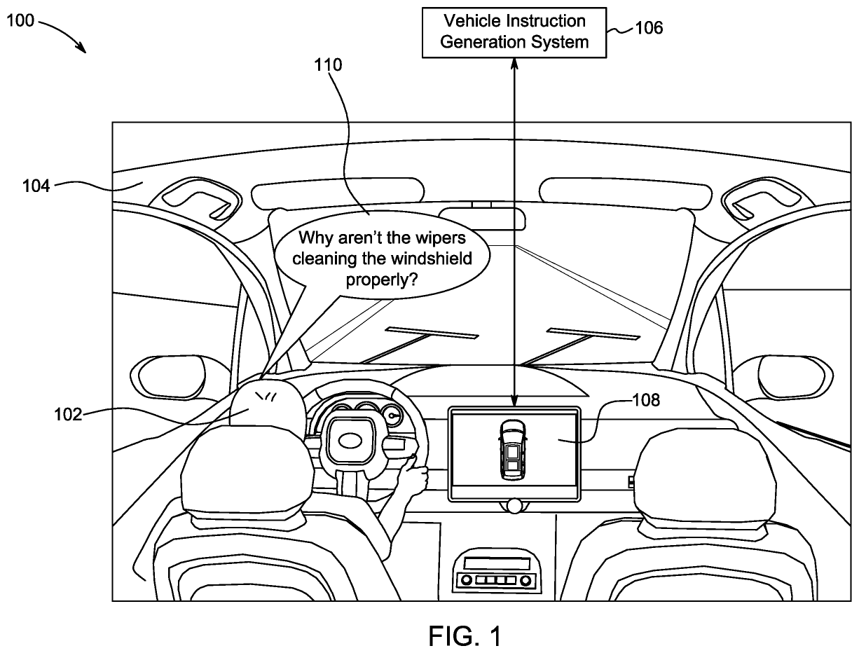

FIG. 1 depicts an example environment 100 in which techniques and structures for providing the systems and methods disclosed herein may be implemented. The environment 100 may include a user 102 sitting inside a vehicle 104. The vehicle 104 may take the form of any passenger or commercial vehicle, for example, a car, a work vehicle, a crossover vehicle, a truck, a van, a minivan, a taxi, a bus, etc. The vehicle 104 may be a manually driven vehicle, and/or may be configured to operate in a partially or fully autonomous mode, and may include any powertrain such as, for example, a gasoline engine, one or more electrically-actuated motor(s), a hybrid system, etc.

In some aspects, the user 102 may be in need of an assistance associated with the one or more vehicle components of the vehicle 104. In an exemplary aspect, the user 102 may be in need of an assistance when the user 102 may have to install or replace a vehicle component in the vehicle 104, repair a vehicle component, operate a new vehicle component that the user 102 may not be aware of (or may not know the procedure to operate), perform maintenance of a vehicle component, and/or the like. In such instances, the user 102 may output a command to the vehicle 104 to view one or more video content that may provide the required assistance to the user 102. The video content may be, for example, an instructional or educational video content or a “how-to” video that may provide step-by-step instructions to the user 102 that the user 102 may be required to execute/perform to complete the task associated with one or more vehicle components.

The vehicle 104 may be communicatively coupled with a vehicle instruction generation system 106 (or system 106) that may be configured to obtain the user command (e.g., a voice-based command or user input), and generate an instructional media content (e.g., a “how-to” video) associated with one or more vehicle components to be provided to the user 102 based on the user input. In some aspects, the system 106 may be part of the vehicle 104. In other aspects, the system 106 may be part of a server (not shown) and communicatively coupled with the vehicle 104 via a wireless network.

The system 106 may be an Artificial Intelligence (AL)/Machine Learning (ML) based system configured to generate the instructional media content associated with one or more vehicle components on the fly based on the user input, irrespective of whether the user 102 provides an explicit command associated with the vehicle components or an implicit command. For example, the user 102 may provide an explicit voice command (or an explicit user input) to the system 106 stating, “Show me how to add wiper fluid”. In this case, the system 106 may obtain the explicit command from the user 102, and generate an instructional media content (e.g., a how-to video) illustrating the user 102 the procedure to add the wiper fluid. Responsive to generating the instructional media content, the system 106 may cause a display screen 108 associated with a vehicle Human-Machine Interface (or a display screen associated with a user device) to display the generated instructional media content.

When the user 102 provides an implicit voice command (or an implicit user input), e.g., “Why aren't the wipers cleaning the windshield properly” (as shown by a view 110 in FIG. 1), the system 106 may first determine a user intent based on or from the user input. In some aspects, the system 106 may include a Large Language Model (LLM) agent that may include one or more algorithms and/or trained machine models (trained using supervised machine learning algorithms), which may assist the system 106 to analyze the implicit user input by using natural language processing and determine the user intent. In further aspects, the system 106 may determine the user intent by performing one or more of a sentiment analysis, an emotion analysis, a user age analysis, and/or the like of the implicit user input, by executing instructions associated with one or more natural language processing algorithms of the LLM agent.

By determining the user intent, the system 106 may identify a “real objective” of user's input or one or more possible reasons that led to the user 102 providing the implicit user input to the system 106. For example, when the user 102 provides the command as shown in the view 110, the system 106 may determine that either the vehicle wipers may be broken or need repair, or the wiper fluid needs to be added.

Responsive to determining the user intent, the system 106 may identify one or more vehicle components associated with the determined user intent. By continuing with the example described above, the system 106 may determine the wipers and/or the wiper fluid as the vehicle components associated with the user intent. Stated another way, the system 106 may identify that the implicit user input may be related to wipers and/or the wiper fluid, or the user 102 may have provided the implicit user input to the system 106 as the user 102 may be facing issues with the wipers and/or the wiper fluid. In some aspects, the system 106 may identify the vehicle component(s) based on the user intent by executing instructions stored in one or more trained machine models that may be part of the LLM agent. In an exemplary aspect, the LLM agent may include a trained machine model that may be trained by using a training data including a plurality of user command intents and a plurality of vehicle components identifiers. The trained machine model may be configured to predict or estimate a vehicle component identifier (and hence a corresponding vehicle component, e.g., the wipers, the wiper fluids, etc.) based on a user intent fed into or provided as input to the trained machine model. The system 106 may use the instructions included in the trained machine model to identify the vehicle component(s) that the user 102 may be referring to in the implicit user input (or facing issues with) based on the determined user intent.

In some aspects, the system 106 may further identify the vehicle component(s) (or confirm the vehicle component(s) identified by using the LLM agent described above) based on internal vehicle data/information, e.g., measured wiper fluid levels, detected electrical malfunction, diagnostic trouble codes or DTCs, and/or the like. The system 106 may obtain such internal vehicle data from one or more vehicle sensors and/or individually from the vehicle components.

Responsive to identifying the vehicle component(s), the system 106 may generate an instructional media content on the fly based on the determined vehicle component and the user intent. For example, the system 106 may generate an instructional video illustrating the step-by-step procedure to add the wiper fluid when the determined vehicle components may be associated with the wiper fluid.

As described above, the system 106 further performs sentiment analysis, emotion analysis, and/or user age analysis of the user input to determine the user intent. In some aspects, the system 106 performs the sentiment and/or emotion analysis to determine whether the user 102 may be calm, agitated, confused, in a hurry, scared, panicking, etc., and the user age analysis to determine a possible age-profile of the user 102. The system 106 may be configured to generate the instructional media content based on the sentiment analysis, the emotion analysis, and/or the user age analysis. As an example, the system 106 may generate a more sophisticated and detailed step-by-step instructional video when the system 106 determines that the user 102 may be an adult, and may generate a generic video when the user 102 may be a curious kid. In additional aspects, the system 106 may determine the user intent based on known user profiles associated with vehicle users, especially if more than one user may be regularly using the vehicle 104. The user profiles may include known user traits, characteristics, etc., and the system 106 may “learn” such user profiles associated with the vehicle users over time, as the users use the vehicle 104. In other aspects, such user profiles may be added/provided by the respective users to the system 106.

In some aspects, the system 106 may generate the instructional media content by executing instructions associated with one or more video generation modules/models that may be part of the LLM agent. The video generation module may generate the instructional media content based on a user manual associated with the vehicle 104 (that may be pre-stored in a system memory), the determined vehicle component(s) and user intent, one or more pre-stored video shots associated with the vehicle component(s), a three-dimensional (3D) digital vehicle exterior and interior model (that may be pre-stored in the system memory), and/or the like. As an example, when the vehicle components may be associated with the wiper fluid, the video generation module may use one or more pre-stored video shots associated with a vehicle bonnet, a wiper fluid tank, and/or the like, to “stitch” together and generate an instructional media content on the fly, based on the user intent and the pre-stored video shots. In some aspects, the instructional media content may use the 3D vehicle exterior and interior model (or 3D vehicle model) as a “base” so that the media content is three-dimensional in nature, and hence more immersive and helpful in assisting the user 102 (e.g., to conveniently teach the user 102 the procedure to add the wiper fluid).

Responsive to generating the instructional media content, the system 106 may cause the display screen 108 to display the instructional media content. In some aspects, the system 106 may additionally determine an optimal view angle (or an optimal “camera angle”) to display the instructional media content using the 3D vehicle model on the display screen 108, so that the user 102 may easily and efficiently understand the instructional media content. The system 106 may determine the optimal view angle based on the determined vehicle component(s) and the user intent. As an example, if the vehicle components are associated with the wiper fluid, the system 106 may determine that the optimal view angle to display the instructional media content using the 3D vehicle model may be a vehicle front top view (as opposed to a side view or a back view of the 3D vehicle model), so that the user 102 may efficiently and clearly view the steps shown in the instructional media content and understand the procedure to add the wiper fluid.

Responsive to determining the optimal view angle, the system 106 may cause the display screen 108 to display the 3D vehicle model at the optimal view angle, and then begin to display or “play” the instructional media content. In some aspects, the system 106 may additionally output captions (e.g., textual captions, pictorial captions, and/or the like) and/or audible prompts associated with the steps included in the instructional media content, as the instructional media content may be getting displayed/played on the display screen 108. The captions and/or audible prompts may enhance user convenience of viewing the instructional media content and may enable the user 102 to easily comprehend the steps being displayed on the instructional media content.

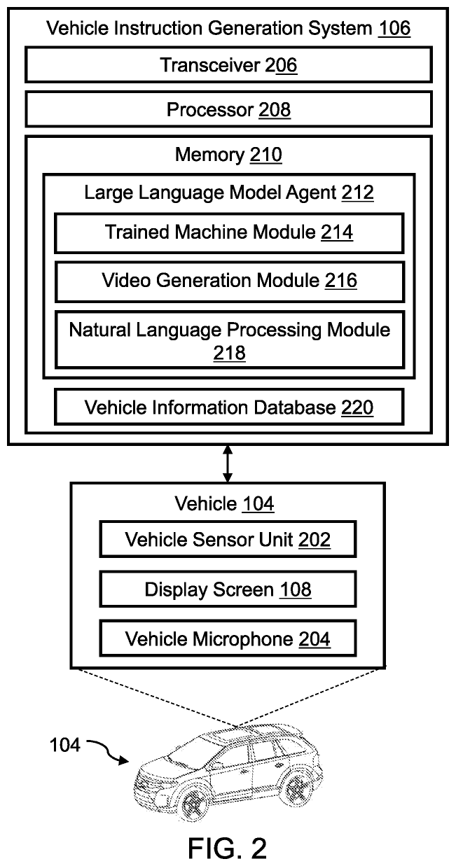

Further system details are described below in conjunction with FIG. 2.

The vehicle 104 and the system 106 implement and/or perform operations, as described here in the present disclosure, in accordance with the owner manual and safety guidelines. In addition, any action taken by the user 102 should comply with all the rules specific to the location and operation of the vehicle 104 (e.g., Federal, state, country, city, etc.). The notifications, recommendations or the media content, as provided by the vehicle 104 or the system 106, should be treated as suggestions and only followed according to any rules specific to the location and operation of the vehicle 104.

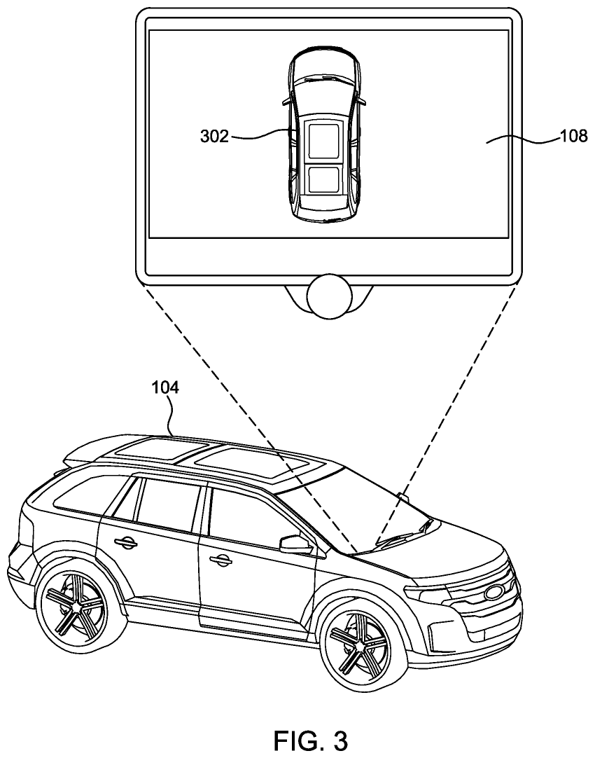

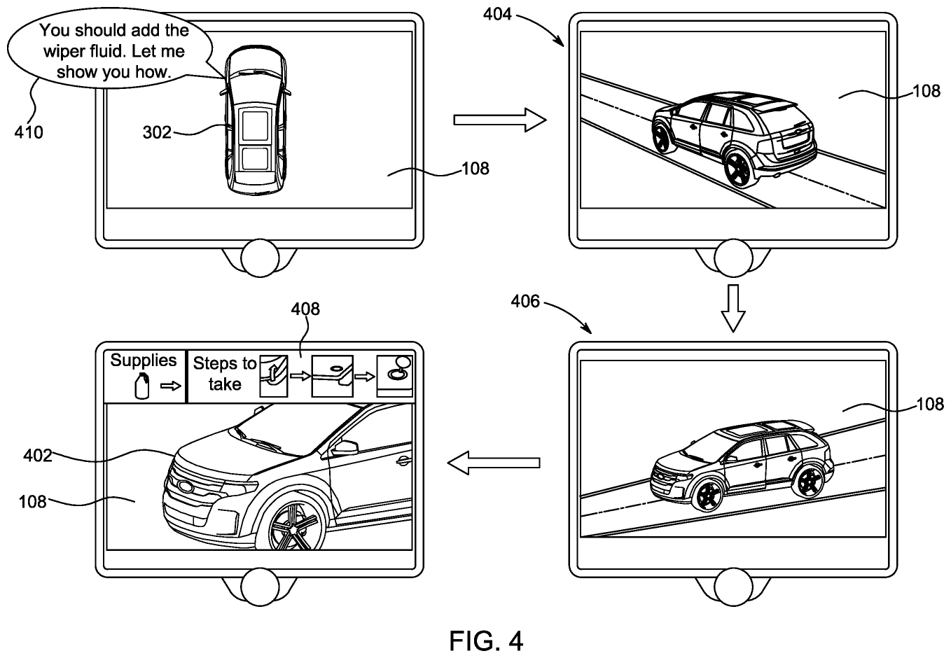

FIG. 2 depicts a block diagram of the vehicle instruction generation system 106 in accordance with the present disclosure. As described above in conjunction with FIG. 1, in some aspects, the system 106 may be part of the vehicle 104. In other aspects, the system 106 may be part of a server (not shown) that may be communicatively coupled with the vehicle 104 via a wireless network. The wireless network may be and/or include the Internet, a private network, public network or other configuration that operates using any one or more known communication protocols such as, for example, transmission control protocol/Internet protocol (TCP/IP), Bluetooth®, BLE, Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples. In yet another aspect of the present disclosure, one or more system components may be part of the vehicle 104, and remaining system components may be part of a server. While describing FIG. 2, references will be made to FIGS. 3 and 4.

The vehicle 104 may include a plurality of units/components including, but not limited to, a vehicle sensor unit 202, the display screen 108 associated with a vehicle HMI, a vehicle microphone 204, and/or the like. The vehicle sensor unit 202 may be configured to measure/detect inputs associated with a vehicle operating status (i.e., whether the vehicle engine is in ON or OFF state, whether the vehicle 104 is in motion or stationary, etc.), a vehicle speed, a vehicle geolocation (e.g., via signals obtained from a Global Positioning System), a weather condition (e.g., temperature, presence of snow, rain, sunlight, ambient light intensity, etc.) associated with a vehicle surrounding, a vehicle occupant status, and/or the like. The vehicle sensor unit 202 may transmit the inputs described above (or “sensor inputs”) to the system 106 at a predefined frequency.

The vehicle microphone 204 may be configured to capture the voice-based command (e.g., implicit or explicit user input, as described above in conjunction with FIG. 1) provided by the user 102 to the vehicle 104. The vehicle 104 may be configured to transmit (via a vehicle transceiver, not shown) the user input captured by the vehicle microphone 204 to the system 106.

A person ordinarily skilled in the art may appreciate that the vehicle 104 may include a plurality of additional units/components that are not shown in FIG. 2 and not described in the present disclosure. The vehicle units/components depicted in FIG. 2 are for illustrative purpose, and should not be construed as limiting. The vehicle 104 may include additional units/components, without departing from the present disclosure scope.

The system 106 may include a plurality of units/components including, but not limited to, a transceiver 206, a processor 208 and a memory 210. The transceiver 206 may be configured to receive/transmit data/information/signals/media content from/to external systems and devices. For example, the transceiver 206 may receive the sensor inputs from the vehicle sensor unit 202, the implicit or explicit user input (provided by the user 102) from the vehicle 104, and/or the like. The transceiver 206 may further transmit the instructional media content and/or the 3D vehicle model to the vehicle 104 to cause the display screen 108 to display the instructional media content and/or the 3D vehicle model. The transceiver 206 may additionally transmit audio prompts to the vehicle 104, which may be output by the vehicle 104 along with the instructional media content via one or more vehicle speakers (or via the vehicle HMI).

The processor 208 may be an Artificial Intelligence (AI)/Machine Learning (ML) based processor that may be disposed in communication with one or more memory devices disposed in communication with the respective computing systems (e.g., the memory 210 and/or one or more external databases not shown in FIG. 2). The processor 208 may utilize the memory 210 to store programs in code and/or to store data for performing aspects in accordance with the disclosure. The memory 210 may be a non-transitory computer-readable storage medium or memory storing program codes that may enable the processor 208 to perform operations as per the present disclosure. The memory 210 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In some aspects, the memory 210 may include a plurality of databases, modules, and agents including, but not limited to, a large language module (LLM) agent 212, a trained machine module 214 (or a trained machine learning module), a video generation module 216, a natural language processing module 218, and a vehicle information database 220. The vehicle information database 220 may be configured to store information associated with the vehicle 104, e.g., information associated with a user manual of the vehicle 104, a three-dimensional (3D) digital vehicle interior and exterior model (or 3D vehicle model), names/labels of a plurality of vehicle components, pre-generated or pre-loaded video shots associated with the plurality of vehicle components, and/or the like.

In some aspects, the trained machine module 214, the video generation module 216 and the natural language processing module 218 may be part of the LLM agent 212, as shown in FIG. 2. In other aspects, one or more of the trained machine module 214, the video generation module 216 and the natural language processing module 218 may be outside the LLM agent 212. The trained machine module 214 may be trained (e.g., by using supervised machine learning technique/algorithm) by using a training data that includes a plurality of vehicle component identifiers (e.g., names/labels of a plurality of vehicle components) and a plurality of user command intents. In some aspects, the training data may be stored in the memory 210, or a remote server that may be communicatively coupled with the system 106. The trained machine module 214 may be trained by the processor 208 (by using the training data), and may be configured to output names/labels of possible vehicle components when a user intent may be input to the trained machine module 214.

The natural language processor processing 218 may store instructions associated with one or more natural language processing algorithms that may be configured to determine the user intent from a natural language voice command-based user input (e.g., the implicit or explicit user input described above in conjunction with FIG. 1) by performing natural language processing, sentiment analysis, emotion analysis, user age analysis, and/or the like of the user input. In additional or alternative aspects, as described above, the system 106 may determine the user intent based on known user profiles associated with vehicle users, especially if more than one user may be regularly using the vehicle 104. The details of user profiles are already described above in conjunction with FIG. 1.

The video generation module 216 may be configured to generate an instructional media content (e.g., a “how-to” video) on the fly based on the user intent, the vehicle component(s), the information associated with the user manual, and/or the sensor inputs (obtained from the vehicle sensor unit 202). In some aspects, the video generation module 216 may use the video shots and/or the 3D vehicle model stored in the vehicle information database 220 to generate an optimal instructional media content that may provide contextually relevant assistance to the user 102 according to the situation the user 102 may be in or based on user's exact requirements.

In some aspects, the LLM agent 212 may include one or more additional modules, in addition to the modules described above, without departing from the present disclosure scope. The LLM agent 212 may use the instructions included in the modules to correctly determine user's intent from the user input (i.e., from the user's natural language voice command), generate relevant instructional media content for the user 102, and enable the display screen 108 to optimally display/output the instructional media content so that the user 102 may comprehend the media content in the most efficient and easy-to-understand manner.

In some aspects, the modules included in the LLM agent 212 may be trained by the processor 208 using supervised machine learning technique. A person ordinarily skilled in the art may appreciate that machine learning is an application of Artificial Intelligence (AI) using which systems or processors (e.g., the processor 208) may have the ability to automatically learn and enhance from experience without being explicitly programmed. Machine learning focuses on use of data and algorithms to imitate the way humans learn. In some aspects, the machine learning algorithms may be created to make classifications and/or predictions. Machine learning based systems may be used for a variety of applications including, but not limited to, speech recognition, image or video processing, statistical analysis, natural language processing, content generation, and/or the like.

Machine learning may be of various types based on data or signals available to the learning system. For example, the machine learning approach may include supervised learning, unsupervised learning, semi-supervised learning, or reinforcement learning. The supervised learning is an approach that may be supervised by a human. In this approach, the machine learning algorithm may use labeled training data and defined variables. In the case of supervised learning, both the input and the output of the algorithm may be specified/defined, and the algorithms may be trained to classify data and/or predict outcomes accurately.

Broadly, the supervised learning may be of two types, “regression” and “classification”. In classification learning, the learning algorithm may help in dividing the dataset into classes based on different parameters. In this case, a computer program may be trained on the training dataset and based on the training, the computer program may categorize input data into different classes. Some known methods used in classification learning include Logistic Regression, K-Nearest Neighbors, Support Vector Machines (SVM), Kernel SVM, Naïve Bayes, Decision Tree Classification, and Random Forest Classification.

In regression learning, the learning algorithm may predict output value that may be of continuous nature or real value. Some known methods used in regression learning include Simple Linear Regression, Multiple Linear Regression, Polynomial Regression, Support Vector Regression, Decision Tree Regression, and Random Forest Regression.

The unsupervised learning is an approach that involves algorithms that may be trained on unlabeled data. An unsupervised learning algorithm may analyze the data by its own and find patterns in input data. Further, semi-supervised learning is a combination of supervised learning and unsupervised learning. A semi-supervised learning algorithm involves labeled training data; however, the semi-supervised learning algorithm may still find patterns in the input data. Reinforcement learning is a multi-step or dynamic process. This model is similar to supervised learning, but may not be trained using sample data. This model may learn “as it goes” by using trial and error. A sequence of successful outcomes may be reinforced to develop the best recommendation or policy for a given issue in reinforcement learning.

As described above, the modules of the LLM agent 212 may be trained by using supervised machine learning approach. The modules may be updated (or enhanced) as more training data may be fed to the processor 208, e.g., when the processor 208 obtains and “learns” from user inputs provided by the user 102 over a period of time or when the processor 208 obtains updated training data from a remote server.

In operation, the user 102 may transmit/provide a natural language voice command or “user input” to the vehicle 104 when the user 102 may need assistance associated with the vehicle 104. As described above in conjunction with FIG. 1, the user 102 may provide an explicit user input or an implicit (or vague) user input. The vehicle microphone 204 may capture the user input, and the vehicle 104 may transmit the user input to the system 106.

The transceiver 206 may receive the user input from the vehicle 104 (i.e., from the vehicle microphone 204). In addition, the transceiver 206 may receive the sensor inputs from the vehicle sensor unit 202. The transceiver 206 may transmit the received user input and the sensor inputs to the processor 208.

The processor 208 may obtain the user input and the sensor inputs from the transceiver 206. Responsive to obtaining the user input, the processor 208 may determine a user intent based on the user input, as described above in conjunction with FIG. 1. As described above, the processor 208 may additionally determine the user intent based on the user profile(s). In some aspects, the user intent may indicate the exact user requirement associated with the vehicle 104 and/or a reason or a context that may have led the user 102 to provide the user input to the system 106. As an example, when the user 102 provides a voice command, “Why aren't the wipers cleaning the windshield properly?” the processor 208 may determine that the user intent may be to state that the vehicle wipers may be faulty or the wiper fluid may need to be added.

In some aspects, the processor 208 may determine the user intent based on the user input by performing natural language processing. Specifically, the processor 208 may determine the user intent based on the user input by executing instructions associated with one or more natural language processing algorithms stored in the natural language processing module 218. In additional aspects, the processor 208 may execute the instructions associated with the natural language processing algorithms stored in the natural language processing module 218 to perform sentiment analysis, emotion analysis and/or user age analysis of the user input. As described above in conjunction with FIG. 1, the processor 208 may perform the analysis described above to determine whether the user 102 may be calm, agitated, confused, in a hurry, scared, panicking, etc., and/or a possible age-profile of the user 102. In some aspects, the processor 208 may use additional LLM modules (not shown), along with the natural language processing module 218, to determine the user intent based on the user input and/or the user profile(s).

Responsive to determining the user intent, the processor 208 may identify one or more vehicle components that may be associated with the user intent. In some aspects, the processor 208 may identify the vehicle components by executing the instructions stored in the trained machine module 214. Specifically, the processor 208 may “input” the user intent to the trained machine module 214, which may output the expected vehicle components associated with the user intent. For example, when the user intent may indicate that the user 102 desires to add the wiper fluid, the processor 208 may identify one or more vehicle components (e.g., a vehicle bonnet, a wiper fluid tank, and/or the like) that the user 102 may have to access to add the wiper fluid. As described above in conjunction with FIG. 1, the processor 208 may additionally determine/confirm the vehicle component(s) based on the internal vehicle data/information.

Responsive to identifying the vehicle components, the processor 208 may generate an instructional media content (e.g., a how-to video) based on the vehicle components and the user input, which may efficiently teach the user 102 the procedure to perform the task desired by the user 102 (e.g., to add the wiper fluid). In some aspects, the generated instructional media content may be a video content that may include instructions to enable or teach the user 102 to perform one or more of installing the vehicle components, operating the vehicle components, replacing the vehicle components, repairing the vehicle components, and a vehicle component maintenance (e.g., adding the wiper fluid to enable the vehicle wipers to operate properly).

The processor 208 may generate the instructional media content by executing instructions stored in the video generation module 216. As described above, the video generation module 216 may be configured to generate the instructional media content based on the determined user intent, the identified vehicle components, the information associated with the user manual (that the processor 208/video generation module 216 may obtain from the vehicle information database 220) and/or the sensor inputs (that the video generation module 216 may obtain from the processor 208). As an example, if the user intent indicates that the user 108 has to add the wiper fluid, the video generation module 216 may generate a video content (e.g., by using the video shots and/or the 3D vehicle model stored in the vehicle information database 220) that teaches the user 102 the procedure to operate one or more vehicle components to conveniently add the wiper fluid. In an exemplary aspect, the video content may teach the user 102 the procedure to open the vehicle bonnet, the procedure to access the wiper fluid tank, the procedure to fill the wiper fluid, the procedure to close/secure the wiper fluid tank and the vehicle bonnet, and/or the like. As another example, if the sensor inputs indicate that the weather condition in the vehicle's surrounding may be dark and cloudy, the video generation module 216 may generate a video content with low brightness, as compared to when the weather condition may indicate a sunny day or abundant natural or artificial light in the vehicle's surrounding. Similarly, the video generation module 216 may generate a video content with multiple audible or audio prompts when the sensor inputs indicate that the vehicle 104 may be moving, and may include a lesser count of audio prompts when the vehicle 104 may be stationary. As yet another example, the video generation module 216 may generate a detailed step-by-step instructional video content when the user intent indicates that an adult may be providing the user input, as compared to a curious kid (in which case, the video generation module 216 may generate a generic video content). In some aspects, the generated video content may be based on the information included in the user manual or the owner manual, so that the procedure included in or taught by the video content may be in sync with or corroborates with the user manual or the owner manual.

Responsive to generating the instructional media content/video content as described above, the processor 208 may cause the display screen 108 to output/display the instructional media content. In some aspects, to cause the display screen 108 to output/display the instructional media content, the processor 208 may first fetch the 3D vehicle model from the vehicle information database 220, and cause the display screen 108 to output/display the instructional media content by using the 3D vehicle model, as described below.

In an exemplary aspect, the processor 208 may first cause a default view of the 3D vehicle model to be displayed on the display screen 108. In some aspects, the default view on the display screen 108 may be a top view angle of the 3D vehicle model, as shown in FIG. 3. Specifically, as shown in FIG. 3, a top view angle 302 of the 3D vehicle model may be displayed on the display screen 108 when, for example, the generated instructional media content/video content may not be getting displayed or played on the display screen 108. A person ordinarily skilled in the art may appreciate that the default view on the display screen 108 may be any other view angle of the 3D vehicle model as well, different from the top view angle 302, e.g., a side view angle, a back view angle, and/or the like. Hereinafter, the top view angle 302 is referred to as the default view angle 302 in the present disclosure.

In some aspects, before causing the display screen 108 to output/display or play the generated instructional media content, the processor 208 may determine an optimal view angle associated with the 3D vehicle model to display the instructional media content based on the identified vehicle component and the determined user intent. The optimal view angle may be that view angle at which the user 102 may find it most convenient to understand or comprehend the steps shown in the instructional media content. As an example, when the instructional media content may be associated with the procedure to add the wiper fluid, the processor 208 may determine the optimal view angle to be a front top view, a front view or a front isometric view, at which the user may conveniently “see” the steps to be performed on the 3D vehicle model. In some aspects, the processor 208 may determine the optimal view angle associated with the 3D vehicle model by executing the instructions stored in one or more modules of the LLM agent 212.

Responsive to determining the optimal view angle, the processor 208 may cause the view of the 3D vehicle model that may be getting displayed on the display screen 108 to rotate/change from the default view angle 302 to the optimal view angle, as shown in FIG. 4. Specifically, as shown in FIG. 4, the processor 208 may cause the display screen 108 to change/rotate the view from the default view angle 302 to an optimal view angle 402 associated with the 3D vehicle model, in a series or sequence of multiple steps (shown as views 404 and 406 in FIG. 4).

The processor 208 may then cause the display screen 108 to start outputting/displaying/playing the instructional media content responsive to changing/rotating the default view angle 302 to the optimal view angle 402. In some aspects, the processor 208 may additionally generate (e.g., by executing instructions stored in the LLM agent 212) and cause the display screen 108 to display step-by-step pictorial instructions 408 that may enable the user 102 to conveniently learn the steps required to execute the task that the user 102 desires to perform (e.g., add the wiper fluid). In some aspects, the task may require specific supplies, which may or may not be available in the vehicle 104. If the supplies are available in the vehicle 104 (e.g., tire changing kit, portable tire pump, etc.), the instructions 408 may direct the user 102 to the location of those required supplies. On the other hand, if the supplies are not available in the vehicle 104, the vehicle 104 may query a server to identify a method of obtaining the required supplies, e.g., direct the user to a nearby retail location where the required supplies may be available for purchase.

The processor 208 may additionally generate and cause the vehicle speakers (not shown) to output audio commands/prompts associated with the steps shown on the display screen 108 to enable the user 102 to easily understand/comprehend the steps. An example audio prompt stating, “You should add the wiper fluid. Let me show you how.”, is depicted as a prompt 410 in FIG. 4. In an exemplary aspect, the processor 208 may cause the vehicle speakers to output the prompt 410 when the view on the display screen 108 may be changing/rotating from the default view angle 302 to the optimal view angle 402 (or at any time before or after the view changes/rotates). Further, the processor 208 may output the prompt 410 as a response to the user input (which may be, for example, “Why aren't the wipers cleaning the windshield properly?”, as described above in conjunction with FIG. 1). A person ordinarily skilled in the art may appreciate that the audio prompts, views, etc. described in the present disclosure and depicted in the figures are for illustrative purpose only, and should not be construed as limiting.

The user 102 may conveniently view the instructional media content on the display screen 108, and may accordingly execute the task or learn to execute the task that the user 102 desires to perform. In this manner, the system 106 enables the user 102 to conveniently learn about the different features, components, and/or procedures associated with the vehicle 104, without having to manually access the user manual or search on the Internet to seek assistance. The user 102 may additionally pinch and zoom the display screen 108 to zoom-in or zoom-out the views of the instructional media content (e.g., to focus on specific vehicle components) that may be getting displayed on the display screen 108. The user 102 may additionally zoom-in or zoom-out the views based on voice-based commands.

In some aspects, once the instructional media content is generated by the processor 208, the processor 208 may additionally transmit, via the transceiver 206, the instructional media content to a remote server or cloud, so that other vehicles/systems that may require similar instructional media content may fetch (and use) the media content generated by the processor 208 from the remote server or cloud.

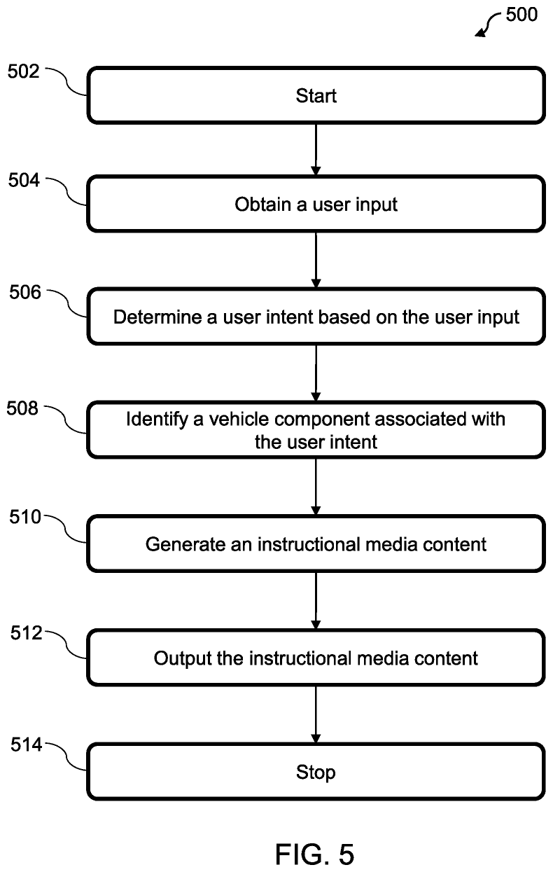

FIG. 5 depicts a flow diagram of an example vehicle instruction generation method 500 in accordance with the present disclosure. FIG. 5 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 500 starts at step 502. At step 504, the method 500 may include obtaining, by the processor 208, the user input. At step 506, the method 500 may include determining, by the processor 208, the user intent based on the user input. At step 508, the method 500 may include identifying, by the processor 208, one or more vehicle component associated with the user intent by executing the instructions stored in the trained machine module 214 or the LLM agent 212.

At step 510, the method 500 may include generating, by the processor 208, the instructional media content/video content based on the vehicle components and the user intent. At step 512, the method 500 may include outputting, by the processor 208, the instructional media content on the display screen 108.

The method 500 may end at step 514.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A system to output vehicle instructions, the system comprising:
a transceiver configured to receive a user input associated with a vehicle from a user;
a memory configured to store a trained machine model, wherein the trained machine model is trained using a training data that comprises a plurality of vehicle component identifiers and a plurality of user command intents; and
a processor communicatively coupled with the transceiver and the memory, wherein the processor is configured to:
obtain the user input from the transceiver;
determine a user intent based on the user input;
identify a vehicle component associated with the user intent by executing instructions stored in the trained machine model;
generate an instructional media content based on the vehicle component and the user intent; and
output the instructional media content.

2. The system of claim 1, wherein the user input is a natural language voice command.

3. The system of claim 2, wherein the memory is further configured to store instructions associated with a natural language processing algorithm, and wherein the processor determines the user intent based on the user input by executing the instructions associated with the natural language processing algorithm.

4. The system of claim 3, wherein the processor is further configured to determine the user intent by performing at least one of a sentiment analysis, an emotion analysis and an age analysis of the user input by executing the instructions associated with the natural language processing algorithm.

5. The system of claim 1, wherein the instructional media content is a video content comprising instructions to perform one or more of installing the vehicle component, operating the vehicle component, replacing the vehicle component, repairing the vehicle component, or a vehicle component maintenance.

6. The system of claim 1, wherein the processor outputs the instructional media content by displaying the instructional media content on a display screen associated with a vehicle Human-Machine Interface (HMI) or a user device.

7. The system of claim 6, wherein the memory is further configured to store a three-dimensional (3D) digital vehicle interior and exterior model, and wherein the processor is further configured to:
fetch the 3D digital vehicle interior and exterior model from the memory; and
display the instructional media content on the display screen by using the 3D digital vehicle interior and exterior model.

8. The system of claim 7, wherein the processor is further configured to:
determine an optimal view angle associated with the 3D digital vehicle interior and exterior model to display the instructional media content, based on the vehicle component and the user intent;
cause the display screen to rotate a default view angle associated with the 3D digital vehicle interior and exterior model being displayed on the display screen to the optimal view angle; and
cause the display screen to display the instructional media content responsive to rotating the default view angle to the optimal view angle.

9. The system of claim 1, wherein the memory is further configured to store information associated with a user manual of the vehicle, and wherein the processor is further configured to generate the instructional media content based on the information associated with the user manual.

10. The system of claim 1, wherein the transceiver is further configured to receive sensor inputs from a vehicle sensor unit, and wherein the sensor inputs comprise inputs associated with at least one of a vehicle operating status, a vehicle speed, a vehicle geolocation, or a weather condition associated with a vehicle surrounding.

11. The system of claim 10, wherein the processor is further configured to:
obtain the sensor inputs from the transceiver; and
generate the instructional media content based on the sensor inputs.

12. The system of claim 1, wherein the system is part of the vehicle.

13. A method to output vehicle instructions, the method comprising:
obtaining, by a processor, a user input associated with a vehicle from a user;
determining, by the processor, a user intent based on the user input;
identifying, by the processor, a vehicle component associated with the user intent by executing instructions stored in a trained machine model, wherein the trained machine model is trained using a training data that comprises a plurality of vehicle component identifiers and a plurality of user command intents;
generating, by the processor, an instructional media content based on the vehicle component and the user intent; and
outputting, by the processor, the instructional media content.

14. The method of claim 13, wherein the user input is a natural language voice command.

15. The method of claim 14, wherein determining the user intent comprises determining the user intent based on the user input by executing instructions associated with a natural language processing algorithm.

16. The method of claim 15, wherein determining the user intent further comprises determining the user intent by performing at least one of a sentiment analysis, an emotion analysis or an age analysis of the user input by executing the instructions associated with the natural language processing algorithm.

17. The method of claim 13, wherein outputting the instructional media content comprises displaying the instructional media content on a display screen associated with a vehicle Human-Machine Interface (HMI) or a user device.

18. The method of claim 17 further comprising:
fetching a three-dimensional (3D) digital vehicle interior and exterior model; and
displaying the instructional media content on the display screen by using the 3D digital vehicle interior and exterior model.

19. The method of claim 18 further comprising:
determining an optimal view angle associated with the 3D digital vehicle interior and exterior model to display the instructional media content, based on the vehicle component and the user intent;
causing the display screen to rotate a default view angle associated with the 3D digital vehicle interior and exterior model being displayed on the display screen to the optimal view angle; and
causing the display screen to display the instructional media content responsive to rotating the default view angle to the optimal view angle.

20. A non-transitory computer-readable storage medium having instructions stored thereupon which, when executed by a processor, cause the processor to:
obtain a user input associated with a vehicle from a user;
determine a user intent based on the user input;
identify a vehicle component associated with the user intent by executing instructions stored in a trained machine model, wherein the trained machine model is trained using a training data that comprises a plurality of vehicle component identifiers and a plurality of user command intents;
generate an instructional media content based on the vehicle component and the user intent; and
output the instructional media content.
